(19) United States
(12) Patent Application Publication
(10) Pub. No.: US 2015/0144166 A1
(43) Pub. Date: May 28, 2015

(54) WALKING FRAME AND FOOT THEREFOR

(71) Applicant: Nottingham Rehab Limited, Leicestershire (GB)

(72) Inventors: John Turner, Derbyshire (GB); Stephen Carnelly, Derbyshire (GB); Jarred William Harris Evans, Cardiff (GB); Ashley Edward Bryant, Cardiff (GB)

(21) Appl. No.: 14/414,304

(22) PCT Filed: Jul. 12, 2013
(86) PCT No.: PCT/GB2013/051856

§ 371 Date: Jan. 12, 2015

(30) Foreign Application Priority Data
Jul. 12, 2012 (GB) 1212432.7

(51) Int. Cl. A45B 9/04; A61H 3/00

(52) U.S. Cl. CPC A45B 9/04; A61H 3/00
USPC 135/67; 135/77

(57) ABSTRACT

A foot 200 for attachment to a leg 180 of a trolley frame 100 designed to assist a user of reduced mobility move about a floor 120. The foot 200 has a first state in which the foot presents a contact surface 224 having a frictional resistance that facilitates slidable contact between the foot 200 and the floor 120 when attached to the leg 180 and when in use, and a second state in which the foot presents an enhanced contact surface 252 having an increased frictional resistance between the foot and the floor to resist said slidable contact. The foot 200 is transferrable between the first and the second states in dependence on a downwardly directed force 190 being exerted by the user on the foot through the leg of the trolley frame to allow the trolley frame 100 to be slid or to resist sliding depending upon the state of the foot.

The present invention relates to a foot for attachment to a leg of a trolley frame designed to assist users of reduced mobility. More particularly, the present invention relates to a trolley with replaceable feet, wherein said feet can be selected to adapt the trolley to the mobility level of the user and/or the required function of the trolley. More particularly, the present invention relates to a foot with two states that provide different resistance to movement of the trolley frame depending upon how the trolley is used.

To maintain people of reduced mobility to be independent within their own homes, they are often supplied with a walking frame to assist them in walking around the house. Walking frames (also known as mobility walkers or just walkers) are typically used by the infirm or elderly to provide assistance when walking. Walking frames are generally provided with 4 legs that assist the user during walking by providing a stable frame to lean against. To move, the user picks up the walking frame and places it a short distance away before walking to it. However, when using the walking frame they are unable to carry anything from room to room. To address this problem, a device was designed called the Buckingham Caddy (GB2397779) that clips onto the walking frame, which provides storage space for transporting goods during use.

Adding castors to walkers allows the user to push the walker rather than having to lift it, making the walker easier to use especially for users with poor arm strength. Such castors are typically wheel castors, as ball castors are subject to a build up of debris over time that restricts their ability to run smoothly. Additionally, using castors for all 4 legs makes the walker difficult to control and does not provide a stable base. Typically, the rear legs are left as ferrules, however these do not slide across the floor easily.

Alternatively, or in addition to the walking frame, users may also be prescribed a trolley to enable them to move items around the house. These are not intended to be used as a walking aid—but frequently are—resulting in the trolley often running away from the user (on unbraked castors) causing falls. Experience has shown that people often use the trolley to carry their meals from the kitchen to the lounge and then use the trolley as a dinner table to eat their meal. This latter functionality is not possible with the Buckingham Caddy. In addition, people can often find themselves with both a walker and trolley by their chair, taking up valuable space within the confines of a small room.

To better control trolleys brakes can be fitted such that, when activated, they lock the castors and allow the trolley to act as a conventional mobility walker or rollator (rolling walker) (a walker mode). Typically these brakes are hand brake levers as found on bicycles and the like. However, such brake levers require a degree of handfunction to operate and require maintenance and adjustment to ensure consistent operation. Especially for the infirm, who may suffer from arthritis making dexterous hand use difficult, reliably operating the brake can be difficult again resulting in the trolley running away from the user.

Instead of adapting the trolley to allow it to be used as a walker, other prior art devices exist that try to improve the useability of walkers. Adding castors or glides (sliders) to walkers allows the user to push the walker rather than having to lift it, making the walker easier to use especially for users with poor arm strength. However, whilst assisting sliding, they offer no grip. These modifications are often added to walkers with the application of tennis balls to the rear feet of the walker being one such option, especially in North America. Although this modification allows the walker to slide with reduced pressure and to grip the floor when load bearing, the tennis balls are subject to heavy wear and need to replaced regularly. Additionally, mounting the tennis balls on the legs can be a difficult process. The present invention aims to alleviate these problems by providing a safer trolley.

According to the present invention there is provided a foot for attachment to a leg of a trolley frame designed to assist a user of reduced mobility move about a floor, said foot having: a first state in which the foot presents a contact surface having a frictional resistance that facilitates slidable contact between the foot and the floor when attached to the leg and when in use, and a second state in which the foot presents an enhanced contact surface having an increased frictional resistance between the foot and the floor to resist said slidable contact, wherein the foot is transferrable between the first and the second states in dependence on a downwardly directed force being exerted by the user on the foot through the leg of the trolley frame.

According to a first aspect of the present invention there is provided a foot for attachment to a leg of a trolley frame designed to assist a user of reduced mobility to move about a floor as defined in claim 1.

Advantageously, such a foot allows a user both to slide the frame in the manner of a trolley when the foot is in the first state and to use the frame to provide a stable base to assist the user in walking when the foot is in the second state. This combines the functionality of a walker and a trolley within a single unit—a hybrid trolley.

In a preferred embodiment, the enhanced contact surface has a higher coefficient of friction than the contact surface. Accordingly, the enhanced contact surface provides an increased frictional resistance to sliding than the contact surface. Typically the material of the contact surface is different to the material of the enhanced contact surface. For example, the contact surface may be nylon or other material with a low coefficient of friction, such as Polytetrafluoroethylene or other durable polymer, and the enhanced contact surface may be a material with a higher coefficient of friction than the contact surface, such as an elastomer. Surface finishes or structures may be provided on the enhanced contact surface to provide an increased frictional resistance between the foot and the floor to resist the sliding contact. Surface roughening and/or corrugations and spikes may also be used. The contact surface polymer may comprise an antimicrobial agent for assisting with killing bacteria.

Preferably, the enhanced contact surface of the second state arises from an increase in contact area to the floor relative to the first state. This allows the foot to act as a brake when a load is applied to the frame. Additionally, the foot can comprise an attachment on one side thereof for facilitating attachment of the foot to the leg of the trolley frame, the contact surfaces being disposed on an opposite side of the foot from the attachment, wherein at least part of the foot is deformable to facilitate the transfer from the first state to the second state. Typically, the deformable part of the foot is an elastomeric material. Being deformable and/or elastomeric provides a smooth transition between the two foot states due to the resilience of the deformable part of the foot. It may be appreciated that any other suitable material, especially one with a high frictional resistance may be used. Generally, the non-deformable part of the foot and in particular the contact surface that facilitates sliding contact between the foot and the floor when attached to the leg and in use is nylon. It may be appreciated that other materials can be used particularly those which provide a low frictional resistance allowing the trolley to be slid along the floor. Furthermore, the attachment can be configured to removably receive a tubular or cylindrically shaped portion of the leg, although it can be appreciated that other shaped legs can be correspondingly received by providing a suitably shaped attachment.

In a preferred embodiment, the foot comprises a cup which defines the contact surface of the first state. The cup can provide an outer housing for the foot and/or may have a flat base that provides the contact surface in the first state. Additionally the foot comprises a core having a surface portion that faces away from the attachment. The cup is preferably annular, defining an opening which surrounds the surface portion, and disposed on the core to separate or space apart the surface portion from the contact surface of the first state. Additionally, the surface portion is urged through the opening when the downward pressure is exerted on the foot so that the cup and the surface portion together define the enhanced contact surface of the second state. Alternatively, the surface portion may be urged through the opening when the downward pressure is exerted on the foot so that the surface portion protrudes beyond the cup so that the surface portion alone defines the enhanced contact surface of the second state.

Advantageously the core is flexible to assist in mounting of the foot to the frame of the trolley. Furthermore, when the surface portion is urged through the opening, the surface portion flexes or deforms about a hinge point in a portion of the core to protrude through the opening. In such embodiments, downward pressure deforms the core to move the surface portion into the second state. By varying the flexibility of the hinge portion, the downwardly directed force required to flex the hinge portion to move the surface portion into the second state can be adjusted and tailored to the body weight and/or strength of the user. For example, by increasing the thickness of the hinge portion the downwardly directed force required to move the foot from the first state to the second state is increased, which may be required for bariatric use of the foot with a trolley. Conversely, reducing the thickness of the hinge portion reduces the downwardly directed force required, which may be useful for paediatric use or for the very frail. It can be appreciated that the flexibility may also be varied by altering the material of the hinge portion or adding support structures to the hinge portion.

In these embodiments, the contact surface and the enhanced contact are formed of different materials, but are part of the same component—rather than being separately located independent elements.

In an alternative embodiment, the material of the contact surface is the same as the material of the enhanced contact surface. The contact surface and the enhanced contact surface may be comprised in a single, unitary component. In this case, the material of the surfaces could be a low, medium or high friction material, with sliding still being achievable due to the dome shape and minimal contact area with the floor in the first state, and braking still being achievable from the increased surface area of contact as a result of applied downward pressure in the second state. The contact surface and enhanced contact surface can, in such embodiments, be formed as a single component/moulding.

According to a second aspect of the present invention, there is provided a trolley for assisting people of reduced mobility, said trolley comprising: a frame; and feet for supporting the frame, at least one of said feet being a foot as defined in the first aspect of the current invention above. The frame and the feet may be provided as a kit of parts. Advantageously, this allows a trolley to be adapted according to the circumstance and mobility of the user. When the foot is in the first state, the user is able to use the frame as a trolley and slide the frame across the floor. This is particularly useful for carrying items across a room using, for example, a removable tray or caddy. When the foot is in the second state, the trolley may be used as a conventional mobility walker to assist in walking and to provide a stable base for the user to lean against. The feet may be push-fit onto the frame or may screw into the frame. The tray may be configured to minimise the impedance of the user's walking gait when using the device as a trolley—so that it is in a combined walker and trolley mode simultaneously.

According to a third aspect of the present invention, there is provided a trolley for assisting people of reduced mobility, said trolley comprising: a frame; and feet for supporting the frame, at least one of said feet being user interchangeable between a plurality of feet types to adapt the trolley to respective ones of corresponding functionalities as required by the user. The frame and the feet may be provided as a kit of parts. Advantageously, this allows a trolley to be adapted according to the circumstance and mobility of the user. By interchanging the feet, the user is able to adapt the trolley to suit the functionality required and/or his/her mobility. This removes the need to use alternative devices for different functionalities, for example a walker for walking and a separate trolley for transporting items. Devices may also be adapted as the mobility level of the user changes to assist in rehabilitation or to provide additional support in the case of deterioration. This also allows, for example, a carer or care home to maintain a stock of a single type of device frame while providing for adaptation of the device for the user by altering the installed feet rather than maintaining a stock of multiple alternative devices. It can be appreciated that either the feet can be interchanged or the feet and a lower portion of the leg, particularly if the frame accepts telescopic rods. In such embodiments, both the telescopic rod and the accompanying foot may be interchanged because the height adjustment requirements differ for different feet.

Preferably the trolley is configured to accommodate a removable tray. This is particularly useful for moving objects around a room, such as food and drinks.

In a preferred embodiment, the functionalities of the trolley include a walker mode and a trolley mode. When the trolley is in walker mode, the trolley may be used as a conventional mobility walker to assist in walking and to provide a stable base for the user to lean against. In the walker mode, at least one of the feet can be a ferrule. When in the trolley mode, the walker can slide across the floor and can be used to transport items around the home. In the trolley mode at least one of the feet can be a castor or slider. Preferably, the plurality of feet types includes at least two selected from: ferrules; sliders; castors; and feet as defined in the first aspect of the current invention. When the trolley is provided with feet as defined in the first aspect of the current invention, the feet facilitate the adaption of the trolley between the trolley mode and the walker mode. The feet may be push-fit onto the frame or may screw into the frame. As noted above, the feet may be connected to telescopic rods prior to attachment to the frame.

The tray may be configured to minimise the impedance of the user's walking gait when using the device as a trolley—so that it is in a combined walker and trolley mode simultaneously. In particular, the tray may be staggered forward such that the rear edge of the tray is in front of the rear castors or sliders, allowing the user to walk closer in towards the handles (more like a walker).

According to a fourth aspect of the present invention, there is provided a kit of parts comprising a foot according to the first aspect of the present invention and at least one foot selected from the following: ferrules; sliders and castors. Additionally, the telescopic rods may also be provided.

According to a fifth aspect of the present invention, there is provided a kit of parts comprising a frame according to the third aspect of the present invention and at least one foot selected from the following: ferrules; sliders; castors and a foot according to the first aspect of the present invention. Additionally, the kit of parts may also comprise one or more telescopic rods.

Embodiments of the invention will now be described by way of example only with reference to the following figures in which:

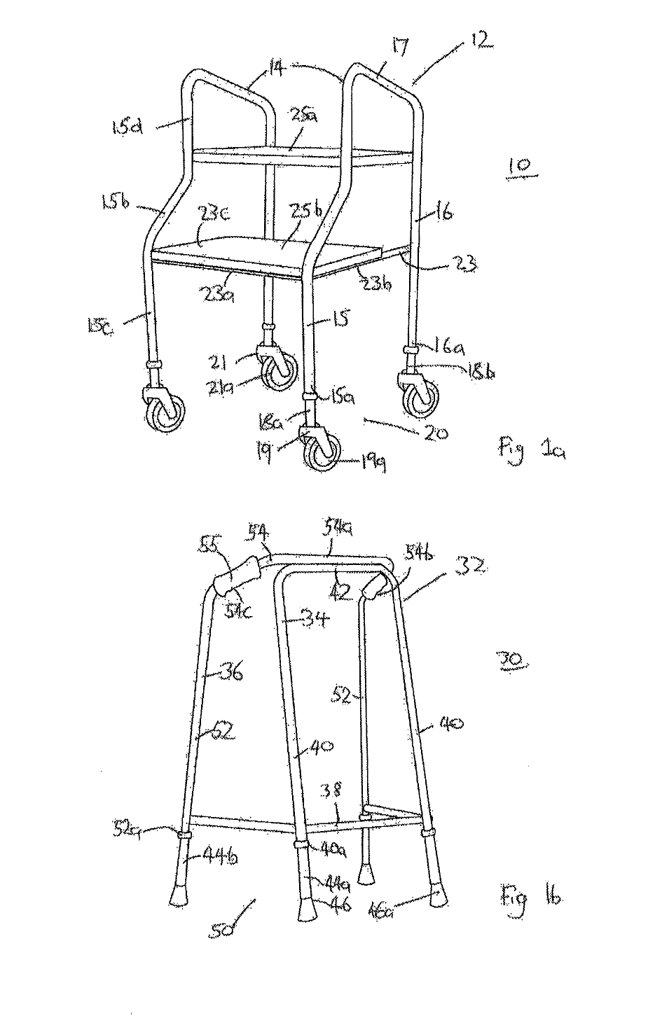

FIG. 1a is a figure of a conventional trolley;

FIG. 1b is a figure of a conventional mobility walker;

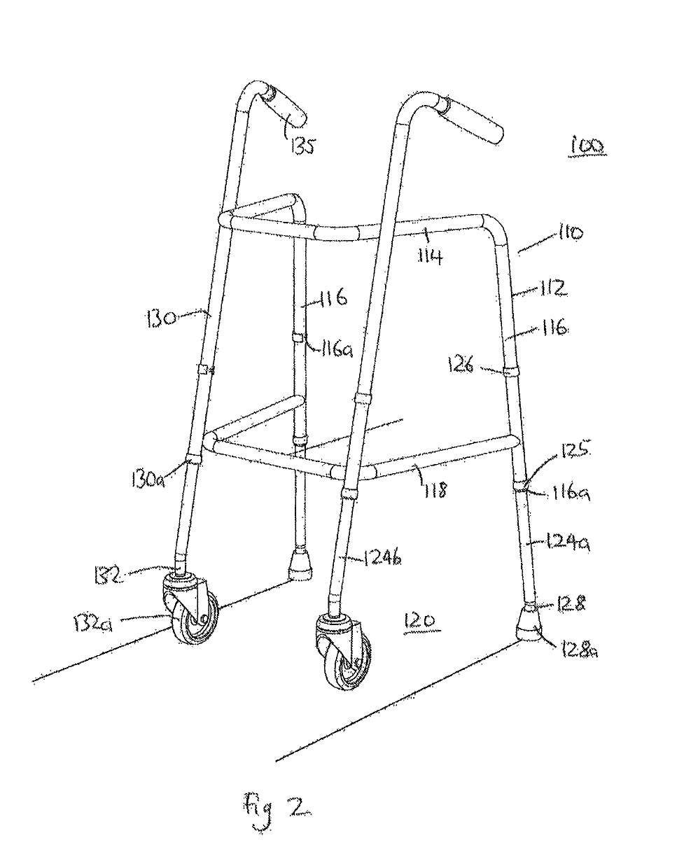

FIG. 2 is a perspective view of a trolley in a first configuration according to one embodiment of a third aspect of the current invention;

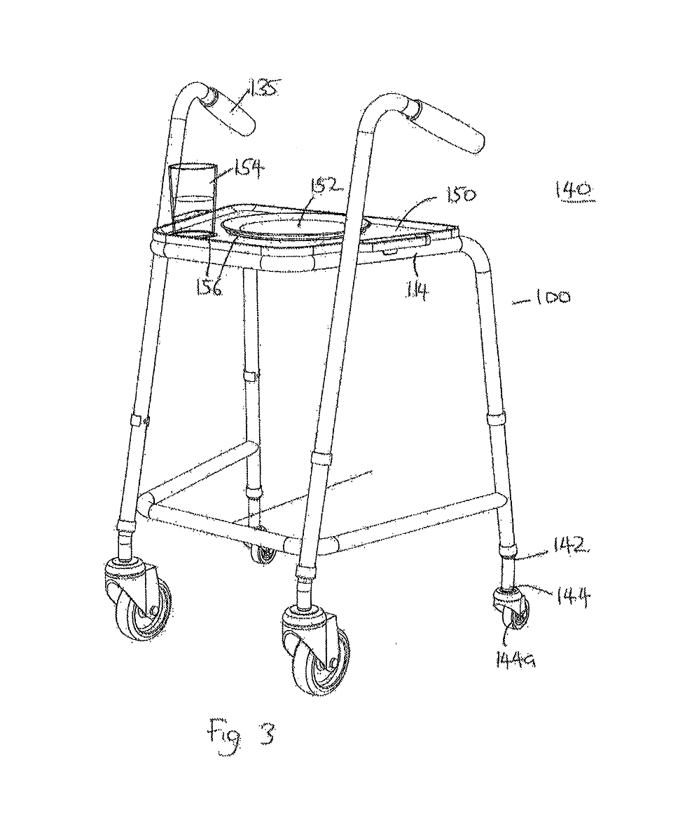

FIG. 3 is a perspective view of the trolley of FIG. 2 in an alternative configuration;

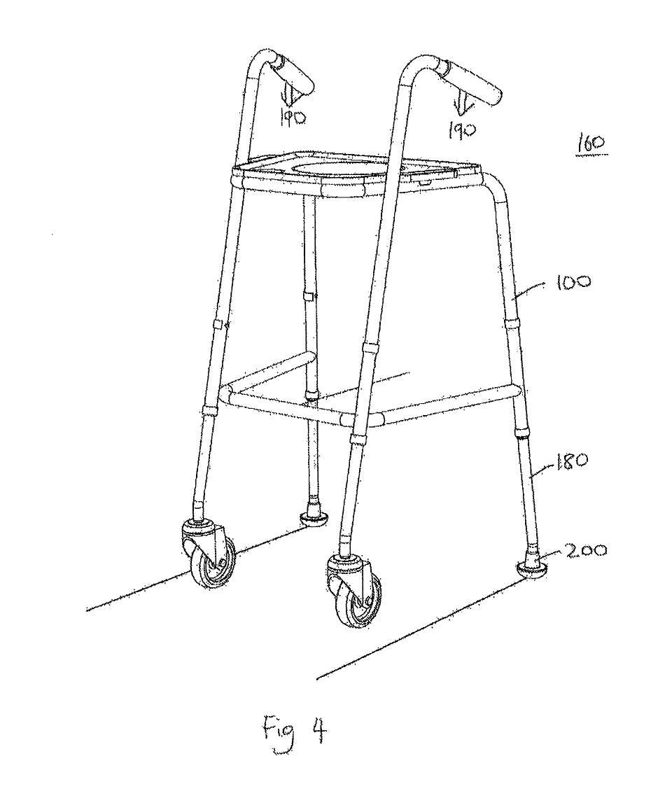

FIG. 4 is a perspective view of the trolley of FIG. 2 in a third configuration;

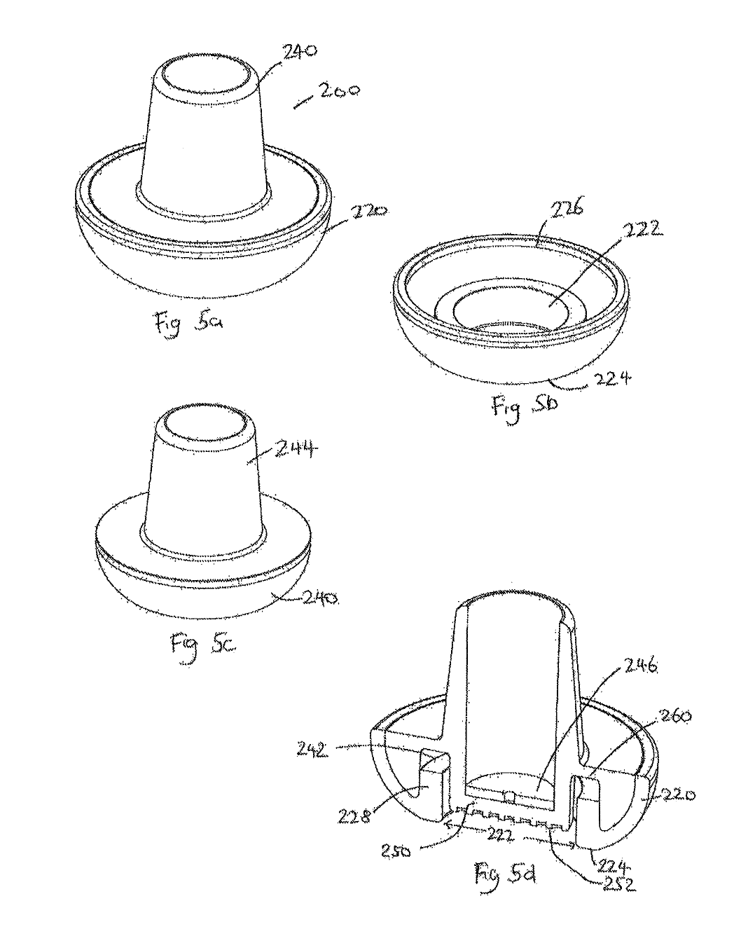

FIGS. 5a-5c show a foot embodying aspects of the current invention;

FIG. 5d is a cross-section of the assembled foot of FIG. 5c;

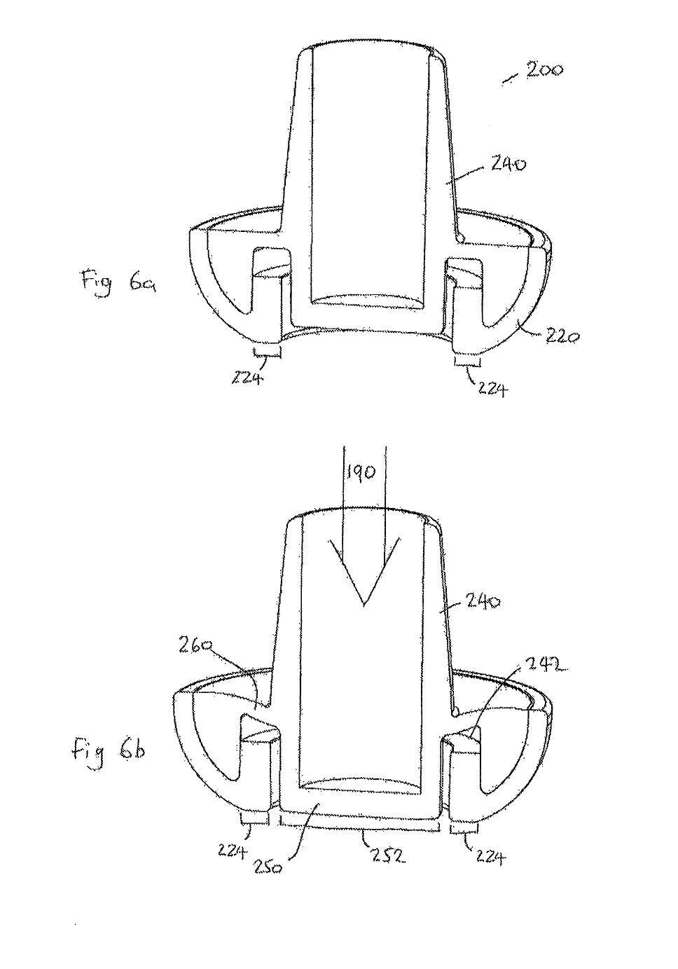

FIG. 6a is a simplified cross section of a foot for a trolley in a first state according to an embodiment of aspects of the current invention; and

FIG. 6b is a simplified cross section of the foot of FIG. 6a in a second state.

FIG. 1a is a schematic view of a conventional trolley 10. The trolley 10 has a frame 12 comprising two lengths of tubing, each providing a side frame 14 of the trolley 10. The side frame 14 is bent to form a front leg 15 (furthest away from the user when the trolley is in use), a rear leg 16 (closest to the user in use) and a horizontal (when in use) handrail 17. Each front leg 15 has a telescopic rod 18a attached to the base 15a of the front leg 15, said telescopic rod 18a comprising a (front) foot 19 terminating in a castor 19a connected thereto. In the illustrated trolley, each front leg 15 additionally has a bend portion 15b to create an offset between the lower portion 15c of the front leg 15 terminating in the base 15a and the upper portion 15d of the front leg leading to the horizontal handrail 17. It can be appreciated that the telescopic rod 18a allows the height of the trolley 10 to be adjusted to suit the intended use and/or the height of the user.

Running parallel to its respective front leg 15, each rear leg 16 is substantially vertical to the ground 20 and protrudes from the horizontal handrail 17. The rear leg 16 terminates in a base 16a with a telescopic rod 18b attached thereto. As per the front leg 15, the telescopic rod 18b of the rear leg 16 comprises a (rear) foot 21 with a castor 21a. It can be appreciated that the front foot 19 and rear foot 21 may be directly attached to the front and rear leg 15, 16 respectively rather than via the telescopic rods 18a, 18b.

The two side frames 14 are connected together by a support frame 23. The support frame 23 is U-shaped as viewed from above and provides a front bar 23a, and two side bars 23b, 23c. As well as acting as a brace for the side frames 14, the front 23a and side 23b, 23c bars together define a space for the user to stand within, such that, in use, the users feet can be placed within the area defined between the front and rear legs 15, 16. The user can then push the trolley 10, which runs on the castors 19a, 21a, to its desired location.

In the example shown, an upper tray 25a and a lower tray 25b is provided on the trolley 10 to enable the user to transport items. As illustrated, the upper tray 25a is constrained between the upper portion 15d of the front leg 15 and the rear leg 16. The upper tray 25a is typically plastic and is attached to the legs 15, 16 at the corner of the tray 25a by clips or the like (not shown). An additional support frame (not shown) may be provided on the frame 12 to acts as a base for the tray. The upper tray 25a is typically used to transport food from the kitchen to the living area and can be tailored for such, with depressions or areas for accommodating a plate, cup etc without them sliding around the tray (not shown). The lower tray 25b is also preferably plastic and is typically supported by the support frame 23 and is attached thereto by clips or the like (not shown). In the example shown, the lower tray 25b rests on part of the support frame 23, but does not extend fully to the rear of the trolley 10, allowing space behind the tray for a users legs such that during use the users knees do not hit the lower tray 25b.

FIG. 1b illustrates a conventional mobility walker 30. The walker 30 comprises a frame 32 formed of three lengths of tubing, a front bar 34, a rear bar 36 and a support bar 38. The front bar 34 (furthest from the user when in use) comprises a length of tubing bent to form two front legs 40, interconnected by a horizontal top front bar 42. Each front leg 40, when connected to the rear and support bars 36, 38 is angled approximately 10 degrees off vertical such that, in use, the top front bar 42 is angled towards the user and the front legs 40 are angled away from the user. Like the trolley 10 of FIG. 1a, each front leg 40 terminates in a base 40a with a telescopic rod 44a attached thereto. The telescopic rod 44a terminates in a (front) foot 46 that provide a stable base for the walker. The foot 46 is typically capped with a ferrule 46a that is formed from rubber or other suitable material to provide a frictional resistance to sliding by increasing the grip between the foot 46 and the ground 50. Variants of the conventional mobility walker 30 may be provided with feet 46 that terminate in wheels or castors that can allow some sliding of the mobility walker.

The rear bar 36 (closest to the user when in use) comprises a length of tubing bent to form two rear legs 52 interconnected by a U-shaped handlebar 54. The handlebar 54 comprises a substantially horizontal front portion 54a that is aligned with and connected to the horizontal top front bar 42 to connect the front bar 34 to the rear bar 36. In addition to the front portion 54a, the handlebar comprises left and right side bars 54b, 54c (in relation to the user when in use), each provided with a handle 55 to assist the user in gripping the handlebar 54. Each rear leg 52 terminates in a base 52a with a telescopic rod 44b attached thereto. The telescopic rod 44 also terminates in a (rear) foot 56, typically capped by a ferrule 56a, as per the front feet 46. It can be appreciated that like the trolley 10, the walker 30 is height-adjustable by altering the length of overlap between the telescopic rods 44a, 44b and the legs 40, 52.

In use, a person walks with the frame 32 surrounding their front and sides. The user may then use their hands as additional support by holding the handles 55 of the side bars 54b, 54c. A walker 30 is typically picked up and placed in front of the user, with the user then using the walker 30 as a support to walk forward. The walker 30 can then be picked up again.

FIG. 2 shows a perspective view of a trolley 100. The trolley 100 comprises a lightweight tubular frame 110. The tubular frame is typically formed from hollow aluminium pipe with a typical external diameter of ⅞^{th}'s of an inch (2.2225 cm), although it can obviously be appreciated that other sized and shaped tubing and of different materials can be used. The frame comprises a main bar 112 that is bent to form a substantially U-shaped support 114 and two rear legs 116. The two rear legs 116 protrude from the support 114 such that in use, the rear legs 116 point towards the ground 120 and the support 114 provides a horizontal platform, parallel to the ground 120. A second U-shaped tube that mirrors the shape of the support 114 forms a bracing bar 118 that gives additional structural rigidity to the main bar 112 and the trolley 100.

Each rear leg 116 (i.e. closest to the user when in use) terminates in a base 116a into which a rear telescopic rod 124a is attached that allows the rear leg 116 to be telescopically extended and retracted to alter the height of the trolley 100 to suit the user. An anti-rattle ring 125 can be provided to improve the finish and prevent the rear leg 116 and the telescopic rod 124a from rattling against one another. The rear telescopic rod 124a is telescopically received within the rear leg 116 and is typically formed with a series of holes (not shown) that are aligned with a hole 116a on the inner surface of the rear leg 116. Once the desired height of the rear leg 116 is reached, the hole 116a of the rear leg 116 is aligned with the nearest hole in the telescopic rod 124a and the two are connected with a suitable bolt or euroclip 126 that maintains the telescopic rod 124a in position relative to the rear leg 116. The rear telescopic rods 124a terminate in rear feet 128 capped with ferrules 128a. Such ferrules 128a are typically rubberised and provide an increased resistance to sliding of the frame 112 and assist in providing a stable footing for the trolley 100.

In addition to the rear legs 116, two corresponding front legs 130 are also provided from pieces of aluminium tubing. The front legs 130 are typically bolted onto the U shaped support 114 and the bracing bar 118 to provide additional rigidity for the frame 112 as well as allowing the frame 112 to stand. Like the rear legs 116, the front legs 130 are tubular and have front telescopic rods 124b telescopically attached within and in the base 130a thereof. The front telescopic rods 124b terminate in front feet 132 to which wheels/castors 132a attach that allow sliding movement of the frame 112 when pushed.

The front legs 130 extend beyond the support frame and so are longer in length than the rear legs 116. Each front leg 130 is also provided with a handlebar 134 that facilitates gripping of the frame 110 by the user. The handlebar 134 is bent to be approximately perpendicular to the front leg 130 and is provided with a handle 135 to assist the user in gripping the handlebar 134. The handlebar 134 is generally inclined towards the rear of the frame 110 towards the user to enable ease of use. The base 130a of the front legs 130 is angled away from the vertical towards the user at an angle of approximately 10 degrees, such that, in use, the handle 135 is angled towards the user and the base of the front leg 130 is angled away from the user, again to enable ease of use. In the figure shown, the rods 124a, 124b are extended relative to the frame 112. It can be appreciated that the relative height of the trolley 100 can be tailored by altering the height of the feet 116, 130 to suit the height of the user.

FIG. 3 shows the trolley 100 in an alternative functionality mode. This configuration 140 of the trolley 100 is identical to the configuration shown in FIG. 2, except that the rear telescopic rods 124a and therefore the rear feet 128 have been replaced with alternative rear telescopic rods 142. These rear rods 142 have feet 144 that terminate in castors 144a. In this configuration 140, the trolley 100 is in a trolley mode and can be easily moved by the user pushing against the frame 112 via the handles 135.

Additionally, the configuration of the trolley of FIG. 3 shows a tray 150 attached to the frame 112. Specifically, the tray 150 removably attaches to the support 114 via clips or the like (not shown). The tray 150 provides a stable platform for the trolley 100 to be used to transport plates 152, cups 154 and the like. Depressions 156 may be provided within the tray 150 to further resist sliding of the items 152, 154 on the tray 150 during movement of the trolley 100. It can be appreciated that the tray 150 can be easily incorporated into the configuration of the trolley 100 shown in FIG. 2 or FIG. 4. It can further be appreciated that multiple trays and/or additional storage can be provided. The one or more trays can be designed, as described in relation to FIG. 1a above, to minimise impedance of the user's natural walking gait when using the device as a trolley—so that it is in a combined walker and trolley mode simultaneously. This can be achieved by ensuring the rear edge of the tray is in front of the rear castors or sliders, allowing the user to walk closer in towards the handles (more like a walker).

FIG. 4 shows the trolley 100 in a further alternative dual-functionality mode. This configuration 160 of the trolley 100 differs from those of FIGS. 2 and 3 in that the rear telescopic rods 124a, 142 have been replaced with alternative rear telescopic rods 180 terminating in skid-feet 200. As per earlier configurations, the rear rods 180 may be telescopically attached relative to the rear legs 116 of the trolley 100 to allow the height of the trolley 100 to be adjusted to suit the user or they may attached at a fixed height, or they may be integral with the frame 112. Similarly the skid-feet 200 may be integral with the rear telescopic rods 180 or may be attached to the rear telescopic rods 180 by a push fit or screw-type connection or the like. The skid-feet 200 will be described in detail below, with reference to FIGS. 5 and 6.

In an embodiment, the front castors 132a of FIG. 2, 3 or 4 are direction lock castors. This enables a user or carer to lock the castors 132a to mimic the wheels on a conventional walking frame.

FIGS. 5a to 5c show an embodiment of the skid-feet 200. The skid feet 200 allow the trolley 100, as shown in FIG. 4, to be adapted between a walker mode and a trolley mode through the application of a downwardly directed force 190 exerted by the user via the handles 135 of the trolley 100 that is transmitted through the rear legs 116 of the trolley 100 onto the feet 200 (via the rear telescopic rods 180). In use, if no force 190 is applied to the feet 200 then the feet 200 allow sliding of the trolley 100 relative to the floor 120 (trolley mode). When the user applies force 190 to the feet 200, the feet 200 provide an increased frictional resistance to sliding and provide a stable footing for the trolley 100 (walker mode).

FIG. 5a shows an assembled skid-foot 200. The skid foot 200 generally comprises a cup 220 shaped to support a core 240. The cup 220 is formed in the shape of an annular bowl having an opening 222, the function of which will be described below. The cup 220 is typically made of nylon or other hard smooth material. A contact surface 224 is provided on the base of the cup 220, the contact surface 224 having a frictional resistance that eases sliding between the cup 220 and the floor 120 when mounted to a leg of the trolley 100. A bowl 226, into which the core 240 may sit, is also defined by the cup 220 as shown in FIG. 5a. About the opening 222 is disposed an annular upstand 228 that protrudes from the base of the cup 220 into the bowl 226. The upstand 228 sits within a correspondingly annular shaped slot 242 or recess within the core 240 to provide an attachment between the cup 220 and the core 240. The attachment between the upstand 228 and the slot 242 of the core 240 prevents the core 240 from detaching from the cup 220 during use.

The core 240 is deformable and formed from a flexible elastomeric material. The slot 242 receives the upstand 228 to align and secure the core 240 within the cup 220. The height of the upstand 228 relative to the depth of the slot 242 defines the degree of travel permissible between the core 240 and the cup 220. The core 240 has an attachment 244 deposed away from the cup 220 that allows attachment of the foot 200 to the rear telescopic rod 180 of the trolley frame 100. This attachment 244 is shaped to receive a tubular or cylindrical portion of the rear telescopic rod 180. To protect the base of the attachment 244 from the telescopic rod 180 of the trolley frame 112, a washer 246 can be provided.

Within the core 240 a surface portion 250 is provided that forms the base of the attachment 244 and sits within the upstand 228 of the cup 220. The surface portion 250 is defined by the surface that lies within the annular slot 242, with the base of the surface portion providing a second or enhanced contact surface 252 having a frictional resistance that resists sliding of the contact surface 224 and the enhanced contact surface 252 when mounted to the telescopic rod 180. The material of the enhanced contact surface 252 is chosen to aid frictional resistance (a high coefficient of friction) and is typically an elastomer. The enhanced contact surface 252 is corrugated or dimpled to aid the frictional resistance. Additionally, the enhanced contact surface 252 may also be provided with a roughened surface finish or structures to enhance frictional resistance. Furthermore, a high resistance material may be applied to the base of the surface portion 250 again to provide an enhanced contact surface 252 with a high frictional resistance. The deployment of the surface portion 250 and the enhanced contact area 252 is described with reference to FIG. 6 below.

FIGS. 6a and 6b show simplified cross-sectional views of the foot in a first state (6a) and a second state (6b). When no load 190 is applied to the foot 200, the base 240 sits within the cup 220 of the foot 200 such that, in use, the degree of contact between the foot 200 and the ground 120 is only provided by the contact surface 224 of the cup 220. Due to the low frictional resistance to sliding movement of this surface 224, the trolley 100 is able to slide when a pushing force is applied by a user. This allows the trolley 100 to be used in a manner similar to a conventional trolley 10 to move items around the room/home.

When a load 190 is applied to the foot 200 via the leg 116 (and via the handles 135) of the trolley 100, the load 190 is a downwardly directed force 190 to the surface portion 250 via the base 246 of the attachment 244. This force 190 causes the core 240 to flex or deform at hinge points 260 located above the annular slot 242. This deformation of the core 240 causes the surface portion 250 to be directed downwards and urged to protrude through the opening 222 in the cup 220. As the force is applied, the degree of contact between the foot 200 and the ground is now provided by the contact surface 224 of the cup 220 and the enhanced contact surface 252 of the surface portion 250.

Due to the higher coefficient of friction of the enhanced contact surface 252, the enhanced contact surface 252 (which may be formed of both the enhanced contact surface 252 and the contact surface 224) presents an increased frictional resistance between the foot 200 and the floor 120 so providing a stable footing for the trolley 100 that can resist sliding motion. This allows the trolley 100 to be used in a manner similar to a conventional walker 30.

As noted above, by varying the depth of the slot 242, the thickness of the hinge point 260 can be varied, which in turn determines the downward force required to switch the foot 200 from the trolley mode to the walker mode. This allows the foot 200 to be tailored to the weight and/or physical strength of the user. As an example, the trolley 100 can be adapted for bariatric use by increasing the force required to deform the core 240 and thus to present the enhanced contact surface 252 with the ground 120. For bariatric use, the hinge 260 would be thicker than in the example embodied in FIGS. 5 and 6. This can be achieved by reducing the depth of the slot 242. Similarly, by increasing the depth of the slot 242, the hinge 260 is reduced in thickness and thus weakened, resulting in a lower force 190 being required to switch the foot 200 between the configuration of FIG. 6a and FIG. 6b. Such a foot 200 with a low operating force requirement may be useful for paediatric use.

Further downwardly directed force 190 may cause further flexing or deformation of the core 240, causing the cup 220 to lift away from ground 120. In such an embodiment, the enhanced contact surface 252 of the surface portion 250 lies in contact with the ground 120.

Although shown in combination with a trolley 100, it can be appreciated that the foot 200 could also be used in combination with other devices that use castors, ferrules or the like. For example, the foot 200 could be used in place of castors on chairs, particularly office chairs, children's chairs, perching stools or other chair where the foot 200 is braked when loaded.

1. A foot for attachment to a leg of a trolley frame designed to assist a user of reduced mobility to move about a floor, said foot comprising:
a contact surface having a frictional resistance that facilitates slidable contact between the foot and the floor when attached to the leg; and
an enhanced contact surface having an increased frictional resistance between the foot and the floor to resist said slidable contact; wherein, in use:
in a first state, the foot presents the contact surface to the floor; and
in a second state, the foot presents the enhanced contact surface to the floor, wherein at least part of the foot is deformable to facilitate the transfer between the first and the second states in dependence on a downwardly directed force being exerted by the user on the foot through the leg of the trolley frame and deformation of said at least part of the foot presents the enhanced contact surface to the floor.

2. A foot according to claim 1 wherein the enhanced contact surface has a higher coefficient of friction than the contact surface.

3. A foot according to claim 2, wherein the material of the contact surface is at least partially different to the material of the enhanced contact surface.

4. A foot according to claim 1, wherein the material of the contact surface is the same as the material of the enhanced contact surface.

5. A foot according to claim any preceding claim, wherein the enhanced contact surface has a surface finish or structures that provide an increased frictional resistance between the foot and the floor to resist said slidable contact.

6. A foot according to any preceding claim, wherein the enhanced contact surface of the second state arises from an increase in contact area of the contact surface relative to the first state.

7. A foot according to any preceding claim, wherein said deformable part of the foot is an elastomeric material.

8. A foot according to any previous claim, wherein application of the downwardly directed force exerted by the user transfers the foot from the first state to the second state and release of the application transfers the foot back into the first state.

9. A foot according to any previous claim, further comprising an attachment on one side thereof for facilitating attachment of the foot to the leg of the trolley frame, the contact surface being disposed on an opposite side of the foot from the attachment.

10. A foot according to claim 9, wherein the attachment is configured to removably receive a tubular or cylindrically shaped portion of the leg.

11. A foot according to claim 9 or claim 10, wherein the foot comprises a cup which defines the contact surface of the first state.

12. A foot according to claim 11, wherein the foot comprises a core having a surface portion that faces away from the attachment.

13. A foot according to claim 12, wherein the cup is annular, defining an opening which surrounds the surface portion, and disposed on the core to space apart the surface portion from the contact surface in the first state.

14. A foot according to claim 13, wherein the surface portion is urged through the opening when the downward pressure is exerted on the foot so that the cup and the surface portion together define the enhanced contact surface of the second state.

15. A foot according to claim 14, wherein the surface portion is urged through the opening when the downward pressure is exerted on the foot so that the surface portion defines the enhanced contact surface of the second state.

16. A foot according to any of claims 13 to 15, wherein the core is flexible.

17. A foot according to claim 16, wherein application of the downwardly directed force flexes the core to moves the surface portion into the second state.

18. A foot according to any of claims 12 to 17, wherein the core flexes or deforms about a hinge point to facilitate the transfer between the first and the second states.

19. A foot according to claim 17, wherein the flexibility of the hinge portion determines the downwardly directed force required to flex or deform the core to move the surface portion into the second state.

20. A foot according to any of claims 11 to 19, wherein the cup is dome shaped so that the roof of the dome is presented to the floor in the first state.

21. A foot according to any of claims 11 to 20, wherein the cup and the core are formed as a single piece.

22. The foot of any preceding claim, wherein the contact surface and the enhanced contact surface are comprised in a single, unitary component.

23. The foot of claim 22, wherein the material of the contact surface and the enhanced contact surface is a low, medium or high friction material.

24. A trolley for assisting people of reduced mobility, said trolley comprising:
a frame; and
feet for supporting the frame, at least one of said feet being a foot as defined in any one of claims 1 to 23.

25. A trolley for assisting people of reduced mobility, said trolley comprising:
a frame; and
feet for supporting the frame, at least one of said feet being user interchangeable between a plurality of feet types to adapt the trolley to respective ones of corresponding functionalities as required by the user.

26. A trolley according to claim 25, wherein the trolley is configured to accommodate a removable tray.

27. A trolley according to claim 25 or claim 26 wherein the functionalities include a walker mode and a trolley mode.

28. A trolley according to claim 27, wherein the trolley is configured to accommodate a removable tray and the tray is configured to minimise the impedance of a user's walking gait when using the device as a trolley.

29. A trolley according to claim 27, wherein in the trolley mode, at least one of the feet is a ferrule.

30. A trolley according to claim 27, wherein in the trolley mode at least one of the feet is a castor or slider.

31. A trolley according to any one of claims 25 to 30, wherein the plurality of feet types includes at least two selected from: ferrules; sliders; castors; and feet as defined in any one of claims 1 to 23.

32. A trolley according to claim 30 or 31, comprising a pair of direction lock castors.

33. A foot substantially as described herein and with reference to FIGS. 5 and 6.

34. A trolley substantially as described herein and with reference to FIGS. 1 to 6.

35. A kit of parts containing a foot according to any of claims 1 to 23 and one or more additional feet selected from: ferrules; sliders; and castors.

36. A kit of parts containing a frame and one or more additional feet selected from: ferrules; sliders; castors; and a foot according to any of claims 1 to 23.
